(19) United States
(12) Patent Application Publication
(10) Pub. No.: US 2018/0297908 A1
(43) Pub. Date: Oct. 18, 2018

(54) A GRANULAR FERTILIZER OR SOIL CONDITIONER AND A USE THEREOF

(71) Applicant: BioA Oy, Kotka (FI)

(72) Inventors: Jari JÄRVINEN, Kouvola (FI); Pasi J. VIRTANEN, Lappeenranta (FI); Kati MUSTONEN, Lappeenranta (FI)

(21) Appl. No.: 15/769,936

(22) PCT Filed: Oct. 20, 2016
(86) PCT No.: PCT/EP2016/075220

§ 371 Date: Apr. 20, 2018

(30) Foreign Application Priority Data
Oct. 23, 2015 (FI) 20155753

(51) Int. Cl. C05G 3/00; C05G 3/04; C05C 9/00; C05C 1/02; C05C 3/00; C05B 7/00; C05C 5/04

(52) U.S. Cl. CPC C05G 3/0017; C05G 3/04; C05C 9/00; C05C 5/04; C05C 3/00; C05B 7/00; C05C 1/02

(57) ABSTRACT

A granular fertilizer or soil conditioner (10) containing a bio-based core matrix (12) with at least one nitrogen compound and an inert barrier layer (12) thereon. The fertilizer or soil conditioner may be used to replace commercially available soil conditioners or chemical or mineral fertilizers.

### TECHNICAL FIELD

The present invention relates to a granular fertilizer or soil conditioner and its use. The present invention relates specifically to a granular bio-based fertilizer or soil conditioner containing at least nitrogen. The fertilizer or soil conditioner of the present invention may be, on the one hand, used to replace commercially available soil conditioners or chemical or mineral fertilizers, and, on the other hand, used with certain prerequisites in organic food production.

### BACKGROUND ART

A feature common to all domestic, agricultural, municipal and industrial activities is that they create waste and side flows. The waste and side flows contain both organic and inorganic fractions. Historical prior art method of handling waste and side flows, irrespective of their content or origin, has been to dump such with as little effort as possible. Even nowadays that dumping is, in principle, not allowed the main goal is just to get rid of the waste or side flows with as low expenses as possible. Thus, for preventing harmful substances from getting into the ground waste incineration has been used. Waste incineration is very often performed at a very low efficiency and, moreover, in such a way that combustion gases are allowed to be discharged into the atmosphere in a way that increases environmental load in the form of either only carbon dioxide or possibly many other compounds, in some cases even in the form of toxic or almost toxic compounds. Incineration of the waste leads also to, in practice, final loss of nutrients, as combusting the waste or side flows normally means that, for instance, the nitrogen, vital for the growth of plants, is lost in the form of less desirable NOx emissions, and the phosphorus from the flows remains in the ash that contains heavy metals very often to such an extent that the ash cannot be used but only as landfill in such a manner that plants cannot utilize the phosphorus any more. As to nutrients in general, nitrogen is the most challenging one in view of chemical bonding of bio-based nitrogen. Nitrogen is, by nature, very inert, whereby reactions involving nitrogen require either energy or appropriate chemicals.

In recent years both the strengthening legislation and environmental awareness has led to more and more efficient ways of handling both domestic, agricultural, municipal and industrial waste and side flows such that organic and inorganic fractions are separated and used separately. The organic fraction may be either composted or processed into bioethanol via fermentation or processed into biogas such as methane by means of anaerobic treatment. There is a high need for bio carbon in modern fertilizing agriculture world, too. The list of possible advanced processes for treating organic waste is ever growing. The inorganic fraction—very often combusted ash—also has several application e.g. in the fields of road construction and construction material industry. The ash may be used as land fill material, for noise barriers, and for foundation and covering of landfill sites, just to name a few alternative uses. The use of inorganic ash as fertilizer or soil conditioner has also a long history dating back to the beginning of agriculture.

For instance, in some advanced cases, a certain waste or side flow is taken, for example, to a bio ethanol plant, where specifically bio ethanol is sought to be recovered from the waste, the rest of the end product ending up as waste, i.e. to be either incinerated, handled in connection with waste water processes or dumped as landfill. In some cases also the residual matter from the primary use finds some other application. For example, if the raw material is clean bakery waste, the residual from an ethanol plant may be further used as livestock fodder. However, if the raw material is containing even slightly less pure ethanol raw material, the residual from ethanol production processes has been traditionally taken as waste slurry to municipal waste processing.

In recent years a number of patent documents have come up discussing a more comprehensive approach for processing organic waste material. As an example of those documents WO-A1-2014044945 may be mentioned, the disclosure of which is fully incorporated herein by reference.

The document teaches how the waste and side flows of pulp and paper industry may be taken in efficient use such that, depending on the waste and side flow fractions and processes used, the entire process may result in the production of ethanol, bio gas, construction material and fertilizer. There are, in general, two types of waste and side flows of pulp and paper industry.

The first type is wood and bark based waste flow, mainly originating from the wood yard, that is incinerated as a so called hog fuel in a bark boiler to generate heat and/or electricity and ash. The ash, however, contains heavy metals, but it may be treated by dividing the ash into a coarse ash fraction, which is, by nature, lean in heavy metals, and a fine ash fraction rich in heavy metals. The coarse ash fraction may be taken to fertilizer production and the fine ash fraction, for instance, to construction material industry to replace part of the cement in concrete production.

Another type of waste and side flows are fibrous slurries. The fibrous slurry recovered as filtrates from various processes at a pulp and/or paper mill is taken to a separation stage where the fibrous slurry is divided into a first effluent and a first slurry. The first effluent is taken to a biological waste water treatment plant, from which a clear effluent is discharged to a river, a lake or a sea, and the bio slurry in the bio refinery. The first slurry is further fractionated into one or more coarse fractions and a fine fraction. The fine fraction containing mainly organic matter is taken to the bio refinery, and the coarse fraction/s may be dumped as land fill or used, for instance in fertilizer production. The bio refinery has a fermentation reactor for producing ethanol and/or an anaerobic digester for producing biogas. The residual slurry discharged from the bio refinery is called a digestate. The bio refinery may, optionally, be provided with algae pond for providing more organic matter in the digestate. The biogas collected from anaerobic digestion contains nitrogen, which is stripped from the biogas originating from the anaerobic digestion process as a nitrogen compound, like ammonium sulfate (AS). Stripping means a simple process where ammonia from the bio gas is scrubbed, for instance, with sulphuric acid and recovered as a 40% TS (total solids, dry matter) ammonium sulphate solution.

The above cited WO-reference teaches further that the coarse ash fraction lean in heavy metals and the nitrous compound are taken to fertilizer production to be mixed together with the digestate that is dewatered to increase its dry matter content. Optionally also a coarse fraction collected from the fractionating stage of the first slurry may be used in fertilizer production.

However, the above WO-document, though it explains how the waste and side flows of pulp and paper industry may be taken in full use, does not tell, for instance, how the actual recovery of nitrogen is performed. The WO-document does not pay any attention to the fact that in waste sludges having a neutral pH the nitrogen is often present in the form of ammonium ion, which is highly water soluble, but if the pH is increased for whatever reason the ammonium ions start converting into volatile ammonia. The WO-document only tells that nitrogen may be stripped from the biogas and that nitrogen is also present in the digestate of the anaerobic digestion process, but the actual production of the fertilizer is not described.

Another problem relating to the use of fertilizers or soil conditioners concerns the actual production of the fertilizer or soil conditioner such that the fertilizer or soil conditioner is capable of being stored for months and spread on the field by means of present equipment. In other words, the present equipment, which are designed for spreading commercially available chemical or mineral fertilizers, require that the fertilizer is in the form of granules having maximum dimension of less than 8 mm and that the fertilizer granules are strong enough to withstand the forces a centrifugal spreader subjects to them. The fertilizer granules have to endure also long-lasting compressive stresses when they are stored, for instance, in sacks or bags in piles containing tens of sacks/bags. Also, the granules should be able to withstand moisture, as, though stored in sacks or large bags containing up to 1000 kg fertilizer, there is always some moisture in the air in the sacks or bags and, sometimes, small holes may be punched in the sacks or bags so that additional moist air may get into the sacks or bags.

As to soil conditioners, for instance, there are no such soil conditioners available today that could be spread using centrifugally operating spreaders as the soil conditioners are in the form of powder. Also, long-lasting (over winter) storage of present day soil conditioners is impossible due to their tendency of collecting moisture, and, as a result, either hardening or starting to grow micro-organisms.

In addition to the above granule-related problems, the recovery of nitrogen and the use of recovered nitrogen compounds have a number of other problems.

Firstly, the nitrogen, as well as phosphorus and many other nutrients, like potassium, calcium, etc., too, are present in the waste and side flows in various forms. For instance, the nitrogen is typically bound in proteins. On top of organic phosphorus it may be bound in ferro- or similar flocculating compounds that is the case especially if using municipal sludges. The nutrients may also be in water soluble form (phosphate, nitrate, ammonium, organic nitrogen) and also in a volatile form (ammonia). All the above three forms are present, for instance, in the effluent of anaerobic digestion, i.e. digestate. In other words, when treating the digestate by removing liquid therefrom a considerable part of the nitrogen is removed in the filtrate. Also, for instance, if the pH of the digestate and/or the filtrate is raised, or allowed to raise, to above 7, i.e. to about 7.5 . . . 8 or above, the nitrogen compound starts to evaporate as the ammonium starts converting to ammonia. Thus, the nitrogen has to be recovered from the filtrates and the pH in the process has, at least, to be kept below 8. The nitrogen may be recovered by stripping from gases or by treating filtrates with some other appropriate manner. Other macro nutrients, like phosphorus, potassium etc. as well as micro nutrients, like iron, selenium, boron, etc. are present in the waste and side flows, too, and if combusted they enrich in the ash fraction.

Secondly, the same pH-related problem may be seen in the production of the fertilizer, as, if the pH is allowed to be raised in the production process or somewhere in the storage phase above about 7.5 . . . 8 in the immediate nearhood of the ammonium (NH₄′), volatile ammonia (NH₃) starts forming and the nitrogen content of the fertilizer is reduced equally with the effect on growth of the plants. Additionally, the evaporation of the nitrogen compound means that toxic ammonia is released in air, whereby health-related issues are also at hand.

Thirdly, when considering the use of bio-based matter recovered from domestic, municipal, agricultural and industrial waste and side flows the generally preferred properties of fertilizers or soil conditioners have to be taken into account. Such preferred properties are:
the fertilizer has to include sufficient amount of one or more vital nutrients, like nitrogen, phosphorus, potassium etc., i.e. (NPK+others),
the fertilizer (especially, modern organic fertilizer) has to include bio carbon,
the fertilizer or soil conditioner has to have physical properties such as hardness, size and moisture control to withstand storage conditions (pressure, moisture), as well as field distribution with modern machines and controlled delivery of nutrients to plants,
the fertilizer or soil conditioner has to have chemical properties to withstand microbial activity such as mould, and
the granular fertilizer or soil conditioner should have buffering properties to prevent soil acidification.

### BRIEF SUMMARY OF THE INVENTION

In view of the above, an object of the present invention is to develop such a granular novel fertilizer or soil conditioner that the evaporation of a nitrogen compound as volatile ammonia is prevented.

Another object of the present invention is to develop such a novel granular fertilizer or soil conditioner that is capable of preventing the pH in the nearhood of the nitrogen compound from raising to a value causing the conversion of ammonium (NH₄′) to ammonia (NH₃).

A yet another object of the present invention is to develop a novel granular fertilizer or soil conditioner where both recovered nitrogen compounds and various commercially available nutrients may be used.

A further object of the present invention is to develop a novel granular fertilizer or soil conditioner, where, in addition to nitrogen compound/s used as fertilizer, also ash may be used as a soil conditioner.

A yet further object of the present invention is to develop a novel granular fertilizer or soil conditioner that may, in addition to nitrogen, contain soil conditioners in the form of one or more of burned lime (CaO), calcium carbonate (CaCO₃) and ash each having a high pH value.

A still further object of the present invention is to develop a novel granular fertilizer or soil conditioner that has buffering properties to prevent soil acidification.

One further object of the present invention is to develop a novel granular fertilizer or soil conditioner granule that is provided with a hard shell made of hardening components (like for instance ash, burned lime (CaO), calcium carbonate (CaCO₃), magnesium oxide (MgO), sugar slurry, bio plastics, geopolymers) for enabling the modern operations with centrifugal fertilizer spreading machines.

At least some of the above and other objects of the present invention are met with a granular fertilizer or soil conditioner formed of a core granule comprising bio-based matrix of at least bio-based matter, and an inert barrier layer or coating provided outside the core granule.

Other characteristic features of the present invention become evident from the appended dependent claims and the following description of the various embodiments of the present invention.

By applying the present invention at least some of the following advantages are gained:
instead of incinerating the waste and side flows, utilizing the flows efficiently,
binding of nitrogen, phosphorus and other recoverable nutrients to fertilizer,
not requiring chemical processing,
preventing soil depletion by recovering, among others, phosphorus into a biofertilizer, which reduces the need for chemical fertilizers,
making nutrient cycle more effective (for example, one is able to recover more phosphorus for reuse),
reducing the amount of waste for final disposal,
replacing the lime (CaO) with ash as soil conditioner,
spreading both the fertilizer and the soil conditioner simultaneously reduces work at farms and the compaction of the soil and
taking into use one or more alkaline components that adjust the pH of the soil thus preventing its acidification. Such is needed as agricultural soil is mostly acidic by nature and acidic rain fall is further decreasing the soil pH.

### Definitions

Bio carbon carbon originating from bio-based organic raw materials.

Bio-based matter organic matter recovered directly or indirectly from domestic, agricultural, municipal and industrial waste and side flows. May be derived from animal, human or vegetable matter (e.g. compost, manure). Includes, for instance, restaurant, bakery, slaughterhouse, fishery and dairy wastes, digestate from biogas process, mash from various alcohol (whisky, beer, ethanol) production processes, sludges from various waste water treatment plants (like those of, for instance, mechanical wood processing, pulp, paper or sugar production plants), composted organic waste material, etc.

Biofertilizers fertilizers comprising bio-based matter.

Digestate bio-based matter recovered from aerobic or anaerobic biogas process

Fertilizer used for improving growth of plants. Fertilizers may be divided in chemical, mineral and biomass-based or non-organic and organic fertilizers.

Geopolymers Geopolymers may be classified to pure inorganic geopolymers and organic-containing geopolymers. A geopolymer is essentially a mineral chemical compound or mixture of compounds consisting of repeating units, for example silico-oxide (—Si—O—Si—O—), silico-aluminate (—Si—O—Al—O—), ferro-silico-aluminate (—Fe—O—Si—O—Al —O—) or alumino-phosphate (—Al—O—P—O—), created through a process of geopolymerization. They find use in road construction, building materials, fire resistant composite materials in aircrafts and other vehicles, etc.

Inert understood as such a compound or matter that does not have harmful effects on the nutrient/s, i.e. the nutrients when being in contact with an inert matter or compound do not lose their nutrient value. Inert matter may, thus, be, either virgin or recycled matter, just to name a few examples, a ground mineral, a compound having a favorable pH, recycled side flow, recycled rejectable fiber material, mineral fraction of DIP (deinked pulp) process, etc

MAP Magnesium Ammonium Phosphate, so called kidney stone or bladder stone, not literally nutrient recovered by stripping, but chemically produced nutrient.

Macronutrient chemical elements that are essential for the growth of plants like nitrogen, phosphorus, potassium.

Micronutrient chemical elements that plants require in small amount for their growth, e.g. boron, chlorine, calcium, magnesium, sulphur, manganese, iron, zinc, copper, cobalt, molybdenum, nickel, silicon, selenium and sodium.

Mineral fertilizer natural minerals extracted from mines and processed.

Nutrient water soluble applicable compounds of chemical elements required by plants for their growth. Divided in macronutrients and micro nutrients.

Organic fertilizer biomass-based fertilizers fulfilling the legislative requirements set for organic fertilizers. For instance, in Finland, today, both the nitrogen and ash used in the production of the fertilizer may not be brought from elsewhere but has to be recovered from the plant itself.

Self-hardening a property of a pulverous material, like for instance ash, that when sprayed with water, more generally liquid, stops dusting and, due to chemical reactions, starts hardening and (usually) forming some kind of granules.

Side flow such a material flow from, for instance, an industrial facility that the industrial facility cannot any more use in its own processes but that may be taken forward to be utilized by another user.

Soil conditioner a product which is added to soil to improve the soil's physical qualities, especially its ability to provide nutrition for plants. Soil conditioners may be used to improve poor soils, or to rebuild soils which have been damaged by improper management. They can make poor soils more usable, and can be used to maintain soils in peak condition. Lime, ash, carbonate etc. are the most widely used soil conditioners.

Stripping method of recovering chemical compounds from a stream of gas by scrubbing. Here used for recovering chemical compounds (mainly nitrogen in the form of ammonia) from gaseous fractions from waste and side flows (for instance, anaerobic or aerobic digestion).

Waste flow a flow from an industrial facility that neither the industrial facility itself nor any other facility is able to utilize, i.e. a traditionally worthless flow. For instance, bio sludges/slurries and primary sludges/slurries from a pulp and/or paper mill or sugar production plant.

### BRIEF DESCRIPTION OF DRAWING

In the following, the granular fertilizer or soil conditioner of the present invention and the method of manufacturing thereof is discussed in more detail by referring to the appended drawings, of which

FIG. 1 illustrates schematically the equilibrium between ammonium and ammonia as a function of pH,

FIG. 2 illustrates schematically a granular fertilizer or soil conditioner in accordance with a first preferred embodiment of the present invention,

FIG. 3 illustrates schematically a granular fertilizer or soil conditioner in accordance with a second preferred embodiment of the present invention, and

FIG. 4 illustrates schematically the production process of the granular fertilizer or soil conditioner in accordance with the first and second preferred embodiments.

### DETAILED DESCRIPTION OF DRAWINGS

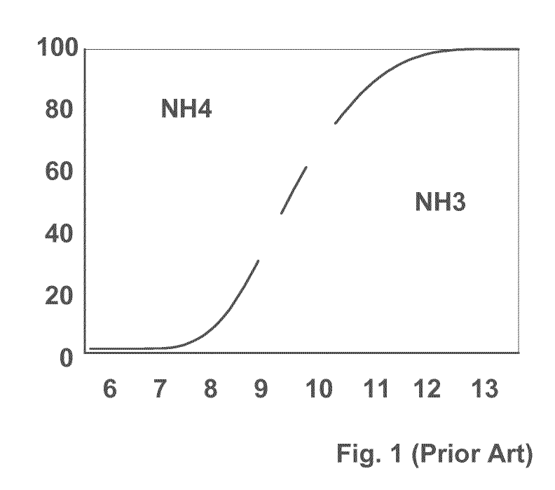

FIG. 1 discusses schematically the basics of the present invention. The graph shows the ammonium/ammonia equilibrium. In practice FIG. 1 shows that when the pH of a liquid, suspension or slurry is low (below about 7) there is no ammonia present, and at a high pH (above about 12) there is no ammonium present. Between pH values 7 and 12 there is both ammonium (NH₄′) and ammonia (NH₃) present. What this means, in practice, for instance, is that if the pH-value of a liquid, suspension or slurry is raised or allowed to raise to a value above 7 . . . 7,5 . . . 8 (somewhat depending on the temperature of the liquid, suspension or slurry) the ammonium in the matrix starts converting to ammonia, which is, in normal temperature, a volatile compound that evaporates into the atmosphere. When doing so the nitrogen content in the liquid, suspension or slurry decreases and ammonia-related problems (odor) in the air increase.

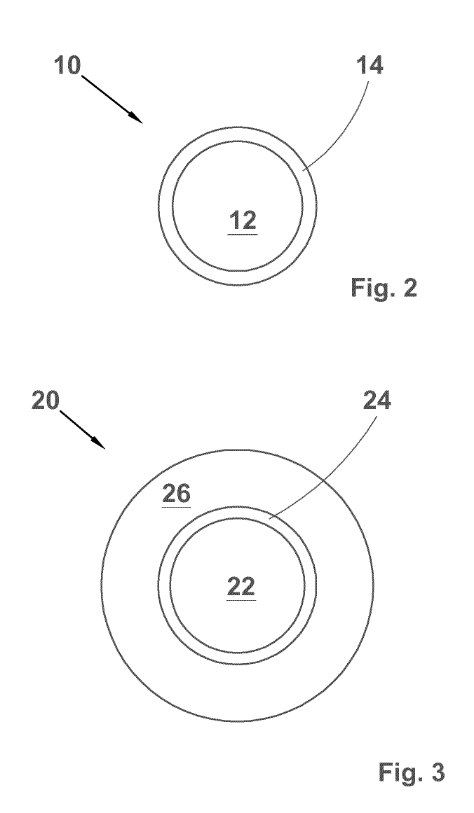

FIG. 2 discusses schematically a granular fertilizer or soil conditioner in accordance with a first preferred embodiment of the present invention. The fertilizer or soil conditioner granule 10 of FIG. 2 comprises a core granule 12 (in broader terms, a first layer), and an inert coating 14 (in broader terms, an inert second or barrier layer). The core granule 12 is, for a significant part thereof, formed of bio-based matter (see ‘Definitions’), like for instance digestate, bio slurry or compost, which is dewatered to appropriate dry solids content of about 70-80% or above by means of, for example, a screw press, filter press or thermal drying and formed into applicable core granules, like for instance pellets, and, preferably, further dried. The bio-based matter contains always some nitrogen, but the share thereof is not always sufficient. Nitrogen, as an example of a number of different nutrients, may be, if desired, depending on the nitrogen or nutrient source, either mixed or absorbed, i.e. not bonded chemically but physically, to the dewatered, preferably dried, bio-based matter before forming the thus created bio-based core matrix to core granules. The pH of the bio-based matter is of the order of 7 or less. The bio-based matter may be mixed with not only nitrogen containing compounds but also with other nutrients, like one or more of phosphorus, potassium, calcium, magnesium, sulphur, boron, chlorine, manganese, iron, zinc, copper, cobalt, molybdenum, nickel, silicon, selenium and sodium, or with other components (like soil conditioners or carbon, preferably bio carbon) of a fertilizer or soil conditioner mixture, as will be discussed later on, without chemical side reactions, to form a bio-based core matrix. There is also a number of other applicable core media that may be used in combination, i.e. mixed with the bio-based matter, like for instance kaolin, talcum, bentonite, silica, silicate, sugar slurry, polylactic acid (PLA), bio plastics, neutral or acidic geo polymers or any combination thereof etc.

There are several sources for the nitrogen in the bio-based core matrix. The first one is, naturally, the nitrogen that is originally present in the bio-based matter. Additionally, nitrogen may be introduced from an outside source, which may be a process where nitrogen is recovered in the form of a water soluble compound, like for instance, ammonium sulfate (AS), ammonium nitrate (AN), ammonium lactate, magnesium ammonium phosphate (MAP), calcium nitrate (CN), calcium ammonium nitrate (CAN), and urea, just to name a few applicable alternatives without any intention to limit the invention to the listed compounds. CN, MAP and CAN may be mentioned as examples of nitrogen compounds that are, firstly, quickly dissolving compounds, i.e. if introduced in the outer layer of the granular fertilizer or soil conditioner their quick dissolution to the soil gives the plants a quick boosting effect soon after the spreading of the fertilizer or soil conditioner, and secondly, they are not sensitive to pH and may thus be used in an alkaline environment without the risk of creating volatile ammonia. Of the above discussed nitrogen compounds sensitive to pH are, thus, ammonium sulfate (AS), ammonium nitrate (AN), ammonium lactate and urea. Other nitrogen compounds sensitive to pH are ammonium acetate, ammonium adipate, ammonium aluminium sulfate, ammonium benzoate, ammonium bicarbonate, ammonium bisulfate, ammonium carbamate, ammonium carbonate, ammonium diethyl dithiophosphate, ammonium dihydrogen phosphate, ammonium ferric citrate, ammonium formate, ammonium hydrosulfide, ammonium iron(II) sulfate, ammonium iron(III) sulfate, ammonium lactate, ammonium lauryl sulfate, ammonium malate, ammonium nitrite, ammonium nonanoate, ammonium oxalate, ammonium phosphate, ammonium polyphosphate, ammonium sulfamate, ammonium sulfide, ammonium sulfite, ethylammonium nitrate, ferric ammonium oxalate, monoethanolamine oleate and ammonium thiosulfate.

As an example of sources of bio-based nitrogen an anaerobic biogas production process may be mentioned where digestate is formed as a side product, and nitrogen compounds, as well as other nutrients, may be separated from both the biogas and the filtrate of the digestate, a part of the nitrogen remaining, however, in the digestate. The biogas collected from anaerobic digestion contains, among other compounds, nitrogen compound/s, which is/are stripped from the biogas as nitrogen compound/s, like for instance ammonium sulfate (AS), ammonium nitrate (AN), ammonium lactate and other nitrogen compounds generally used in fertilizer production depending on the acid used for stripping. For instance, in order to be qualified as an organic fertilizer, it is required that the nitrogen compound used in the production of the fertilizer is based on ammonia stripped by using an organic acid, like for instance lactic acid. Stripping means a simple process where ammonia from the biogas is scrubbed, for instance, with sulphuric, nitric or lactic acid and recovered as a 40% TS (total solids, dry matter) ammonium sulphate, nitrate or lactate solution, from which the ammonium sulphate, nitrate or lactate may further be separated as dry crystals by evaporating the liquid away. The recovered ammonium compound may be utilized as a fertilizer and/or in the production of soil conditioner/s. Nitrogen may also be precipitated from sludge, digestate or combination thereof as, for instance, magnesium ammonium phosphate (MAP) by introducing magnesium ions to the mixture in elevated pH conditions. The above mentioned nitrogen compounds AN, AS and MAP may be precipitated as dry crystals, and thus may be utilized as a pulverous dry matter. Calcium ammonium nitrate (CAN) is one optional nitrogen compound having multiple different, but closely related formulations. An optional version is made by adding powdered limestone to ammonium nitrate. Another, fully water-soluble version, is a mixture of calcium nitrate and ammonium nitrate, which crystallizes as a hydrated double salt.

As another source of bio-based nitrogen various filtrates may be mentioned, like for instance filtrates recovered from domestic, agricultural, municipal and industrial waste and side flows. Optionally, such filtrates may be recovered from at least one of domestic, agricultural, municipal and industrial waste and side flows. In other words, bio-based nitrogen may be derived from animal, human or vegetable matter (e.g. compost, manure). Such includes, thus, also restaurant, bakery, slaughterhouse, fishery and dairy wastes, digestate from biogas process, mash from various alcohol (whisky, beer, ethanol) production processes, sludges from various waste water treatment plants (like those of, for instance, mechanical wood processing, pulp, paper or sugar production plants), etc. Such filtrates may be evaporated and the nitrogen may be stripped from the evaporated vapor.

A further source of nitrogen are commercially available chemically manufactured compounds, like ammonium sulfate, ammonium nitrate, magnesium ammonium phosphate, calcium nitrate, calcium ammonium nitrate, and urea.

The inert coating 14 of the core granule, or the inert second or barrier layer 14 is, preferably but not necessarily, made of at least one of kaolin, talcum, bentonite, silica, silicate, etc. The core granule may also be coated, in addition to the above mentioned material/s or the like, with one or more of organic compounds such as sugar slurry, polylactic acid (PLA) or bio plastics, or inorganic compounds such as geopolymers having acidic or neutral pH, or with any possible combination of the all above listed alternatives. Bio-based matter may also be one of the possible alternatives for the barrier layer, as the pH of the bio-based matter is of the order of 7, and very often the natural nitrogen content of the bio-based matter is very low. Also, as the dry matter content of the bio-based matter is relatively high and the matter is porous the bio-based matter efficiently separates the sensitive nitrogen compounds possibly provided in the core granule from the outside of the coating 14. The purpose of the coating 14 is to prevent the sensitive ammonium compounds of the core granule 12 from getting into contact with any such outside material that could initiate the conversion of ammonium to volatile ammonia or otherwise make the nitrogen inoperable for fertilizing purposes. Another purpose of the coating is to protect the core granule from getting crushed when storing the fertilizer or soil conditioner in sacks or bags stacked one on top of another or when spreading the fertilizer or soil conditioner on the field. The inert coating may, however, contain such nutrients (including also such nitrogen containing compounds, for instance CN, CAN or MAP, that are not sensitive to pH) and/or soil conditioners and/or carbon, preferably bio carbon, that are not sensitive to high pH, outside moisture etc. In other words, the coating material itself may be mixed with such nutrients and/or soil conditioners and/or carbon, preferably bio carbon, upstream of the coating process or such nutrients and/or soil conditioners and/or carbon, preferably bio carbon, may be added to the coating during the coating process. Thus, the coating material is considered inert when it is made to match the type of nitrogen used such that the nitrogen compound does not lose it nutrient value.

The two-layer granule discussed in FIG. 2 may be used as a fertilizer or soil conditioner in itself whereby the volume of the core granule compared to the entire volume of the two-layer granule may be of the order of 5-95%. Thereby, the amount of bio-based matter returned back to circulation may be remarkable, if desired.

However, if desired the granule of FIG. 2 may be provided with a further layer as discussed in FIG. 3, which illustrates schematically a granular fertilizer or soil conditioner 20 in accordance with a second preferred embodiment of the present invention. The granular fertilizer or soil conditioner 20 comprises a core granule 22, an inert coating or barrier layer 24 and an alkaline shell 26. The core granule 22 and the inert coating 24, are similar to those of the first embodiment, i.e. as discussed in connection with FIG. 2. However, the inert coating 24 may be, in this embodiment, thinner than that in the first embodiment, as the inert coating 24 need not, at least alone, carry the compressive and impact loads involved in the storage and the spreading of the fertilizer or soil conditioner.

The alkaline shell, or the third layer, 26 is formed of alkaline shell material, i.e. self-hardening ashes like coal ash or hard coal ash. Other possible compounds include, without any intention of limiting the scope of the present invention to the listed alternatives, CaO or MgO, slag, alkali activated geopolymers etc. In addition to bio-boiler ashes and DIP (deinked pulp) plant ashes, applicable sources of ash are, for instance, lime sludge ash collected from the reburning kiln, green liquor ash and ash from the bark boiler. An important prerequisite for the ash to be used in fertilizer or soil conditioner production is that the heavy metal content of the ash in Finland has to be even as low as below 0,7 mg/kg bone dry (Cd) for the ash to be used as a part of an organic fertilizer in the production of organic food, and below 1,5 mg/kg (Cd) for the ash to be used as a fertilizer in the production of fodder for livestock, or below 25 mg/kg (Cd) when used as a fertilizer in forestry. Here, cadmium has been taken as an example of heavy metals, as most often the Cd-values in the ash are, relatively speaking, the highest. The heavy metal content of the ash may be controlled by either collecting the ash from a source having no or very low share of heavy metals, or by treating the ash to get an ash fraction lean in heavy metals. On the one hand, the above given borderline values for the Cd have to be taken as an example only, as the borderline values are country-specific. On the other hand, there are countries in Central-Europe where the use of ash in fertilizers is today categorically forbidden. However, both the borderline values and the attitude towards the use of ash may change.

The alkaline shell or third layer 26 made of ash or of the other above listed options has multiple functions. Firstly, the shell material itself may act as a soil conditioner by calcificating the soil, secondly, the shell material may contain macro and micro nutrients except for such nitrogen compounds that are sensitive to the alkaline pH of the third layer, thirdly, the shell material may be provided with such additional nutrients and soil conditioners that do not react with or are not sensitive to the pH of the shell material such that its/their nutrient value is lost, fourthly, the shell material may be provided with carbon, preferably bio carbon, and fifthly, the shell material forms a hard shell 26 of the granular fertilizer or soil conditioner 20 protecting the core together with the coating 14 from breaking apart both when storing the fertilizer in sacks or bags and when spreading the granular fertilizer or soil conditioner on the field.

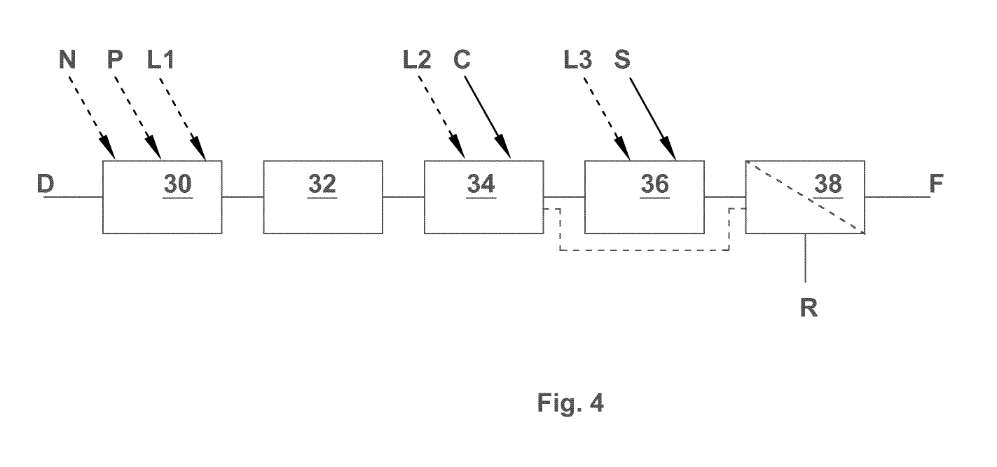

FIG. 4 discusses the method of manufacturing the granular fertilizer or soil conditioner of the first and the second preferred embodiments of the present invention. The production line comprises, in brief, a mixing equipment 30 for mixing the core matrix (though in the simplest embodiment of the present invention the core matrix from which the core granule is made of is pure bio-based matter without any added components or compounds), a first granulator 32 for producing the core granule, or the first layer, of the granular fertilizer or soil conditioner, a second granulator 34 for adding an inert coating, or inert second or barrier layer, on the core granule, a third granulator 36 for adding the alkaline shell, or the alkaline third layer, on the coating of the core granule, and an optional screen 38 for separating granules of unacceptable size. Optionally, one or more screening devices may be added between the various granulators to separate inappropriate granules from the stream of granules.

One of the raw materials for the core granule is bio-based matter D, for instance, digestate of anaerobic digestion or bio slurry (as examples of the vast number of options listed under bio-based matter in “Definitions”). The bio-based matter is thickened before entering the granulation process preferably to a high dry matter content of the order of 70-80% or above. The thickened digestate D (presented as an example of various bio-based matters only) is taken to a mixing equipment 30 where the bio-based matter may be mixed, if desired, also with kaolin, talcum, bentonite, silica, silicate, sugar slurry, polylactic acid (PLA), bio plastics, neutral or acidic geo polymers or any combination thereof, to form a bio-based matrix. Also, water soluble nitrogen compound in the first liquid L1 may be added to the bio-based matter to form a bio-based core matrix. However, if the nitrogen compound added with the first liquid L1 is not sufficient for ensuring the amount of nitrogen in the fertilizer to be produced or no liquid L1 is added, nitrogen N may also be added separately or together with any other part of the bio-based matrix in the mixing equipment 30 either in the form of liquid, powder or minor granules. A factor having an effect on the nitrogen compound to be chosen is its speed of solubility in the humidity of the soil. Also other macronutrient compounds, like for instance phosphorus (P) or potassium (K), and micronutrients like for instance selenium (Se), boron (B), and sulphur (S), as well as various soil conditioners that are to be added to the soil, or carbon, preferably bio carbon, may be added to the mixing equipment either independently or together with some other material so that they are mixed with the bio-based matter to form the bio-based core matrix. Potassium and magnesium may, for instance, be added in the form of biotite.

The first liquid L1 may be pure or fresh water, but is preferably such circulation liquid from an appropriate process that does not contain any compounds reactive with the inert coating material, with the core matrix or with the chemicals mixed in the core matrix. For instance, filtrates recovered from the digestate of anaerobic digestion, from the mash from various alcohol production processes or from the bio slurry (as examples of the vast number of options listed under bio-based matter in “Definitions”) may be mentioned. Also, for instance, industrial waste waters, like filtrates of mechanical wood processing, pulp and paper mill or sugar slurries of sugar industry, etc., containing nutrients may be added in the mixing before the granulation process. In other words, the first liquid L1 may contain nutrients in liquid form. The nutrients and, optionally, soil conditioner/s and/or carbon, preferably bio carbon, may also be added in dry or liquid form in the liquid or bio-based matter upstream of the granulation by means of the heavy duty mixer.

From the mixing equipment 30 the digestate D, or in general, core matrix comprising at least bio-based matter, possibly also nitrogen and, optionally, other nutrients and/or soil conditioners and/or carbon, preferably bio carbon, etc. mixed therein, is taken to a first granulator 32 for forming the core matrix into small core granules. The first granulator 32 is preferably a mechanical press, i.e. for instance a pelletizer, an extruder, a coextruder (EP1579766A2) or the like device that forms the digestate into small core granules having, preferably, but not necessarily, a diameter of about 1-7 mm and a length of, preferably, but not necessarily, about 1-7 mm, keeping in mind the 8 mm maximum size requirement of the spreading machinery in use today. The core granules are pressed in the granulator such that mostly air is removed and the specific gravity of the core granule may become of the order of 7-fold compared to thickened digestate. The thus formed core granules are preferably, but not necessarily, dried thermally to reduce their water content further. The high specific gravity and dryness of the core granule gives a significant part of the strength of the granule against compression and impacts.

The core granules made of digestate (in broader terms, of bio-based core matrix discussed above) are, in accordance with a first variation of this embodiment, discharged from the first granulator 32 to a second granulator 34, which may be a table, disc or drum granulator, like for instance those discussed in EP-A1-0395354, U.S. Pat. No. 3,408,169 and US-B1-6361720. The discharge of the core granules (12, FIG. 2 or 22, FIG. 3) to the second granulator 34 may be done via an optional screening device (not shown) that may be used to separate oversized and/or undersized particles from the stream of core granules. The second granulator 34 is used for providing the small core granules, e.g. pellets, with pulverous inert coating material C and liquid L2 (if needed, i.e. since the core matrix is moist matter, mostly bio-based matter, there may either be no need for liquid L2 or the need is clearly smaller than in case the core matrix was dry). In the second granulator 34 the bio-based matrix granule is moistened, if needed, with second liquid L2 and tumbled together with the inert coating material powder C (kaolin or the like discussed in more detail in connection with FIG. 2) to form the inert coating layer, or barrier layer (14, FIG. 2 or 24, FIG. 3) on the core granule. The second liquid L2 is preferably pure or fresh water or such circulation liquid from an appropriate process that does not contain any compounds reactive with the inert coating material, with the core matrix or with the chemicals mixed in the core matrix. For instance, industrial waste waters, like filtrates of mechanical wood processing or pulp and paper mill or sugar slurries of sugar industry, etc., containing nutrients may be used in the granulation process for coating the core granule. In other words, the second liquid L2 may contain nutrients dissolved in liquid form. As an example of such liquids filtrates recovered from the digestate of anaerobic digestion, from the mash from various alcohol production processes or from the bio slurry (as examples of the vast number of options listed under bio-based matter in “Definitions”) may be mentioned. The nutrients and, optionally, soil conditioners and/or carbon, preferably bio carbon, may also be added in dry or liquid form either independently to the second granulator or mixed with the liquid by means of a heavy duty mixer. The only prerequisite for the nutrient/s and/or soil conditioner/s to be added is that they need to withstand the moistening of the coated core granule or the high pH of the alkaline shell, or the alkaline third layer, arranged, optionally, on the coating material.

If the coated core granule is the desired end product, the coating of the bio-based matrix granule is allowed to proceed for such a period of time that an inert coating thick and strong enough is formed on the core granule, i.e. such that the formed granule is strong enough for enduring the stresses subjected thereto in both storing the fertilizer in sacks or large bags stacked one on top of another, and spreading the fertilizer or soil conditioner on the field. A preferred coating material is, for instance, a combination of an absorbent, like kaolin, silica, silicate, bentonite, talcum, and sugar or corresponding slurry that together form a hard coating on the core granule. Thereafter the coated core granules may be taken, if desired at this stage, (as shown by broken line) to the screen 38, where oversized, and possibly also undersized, coated core granules are separated as reject R from the coated core granules taken out as a fertilizer or soil conditioner F. The fertilizer or soil conditioner F is taken to be sacked or bagged, to be otherwise stored or to be sold directly.

In accordance with a second variation of this embodiment, the first granulator is a coextruder, whereby the coating may be added in the same equipment as the core granule is formed. The coextruder is used for providing on the small core an inert coating by feeding, for instance, at least one of bio-based matter, kaolin, talcum, bentonite, silica, silicate, sugar slurry, polylactic acid (PLA, bio plastics and geopolymers, etc. on the core formed by the first part of the coextruder. However, bio-based matter is the preferred choice in this variation of the present invention. The bio-based matter introduced to form the barrier layer is preferably such bio-based matter where no such nitrogen that is sensitive to pH is added. However, the coating layer may be provided with nutrients (including nitrogen that is insensitive to pH—CN, CAN or MAP) and, optionally, soil conditioners and/or carbon, preferably bio carbon, in dry or liquid form. The only prerequisite for the nutrient/s and/or soil conditioner/s to be added is that they need to withstand the moistening of the coated core granule or the high pH of the alkaline shell, or the alkaline third layer, arranged, optionally, on the coating material. After the coextrusion the thus-formed granules may be further dried, and/or screened and/or taken to further processing, like packaging.

If the coated core granule is to be further provided with another coating layer, i.e. the alkaline shell, or the alkaline third layer, 26 (FIG. 3), the coated core granules are discharged, after a predetermined time period shorter than when the core granules provided with the coating (14, FIG. 2) are the end product, from the second granulator 34 (or from the coextruder) to a third granulator 36, optionally via a screening device (not shown) that separates oversized particles from the stream of coated core granules. In the third granulator 36, which may be a table, disc or drum granulator as discussed above, the coated core granules are moistened, if needed, with third liquid L3 and tumbled with the shell material S for such a period of time that a shell 26 in FIG. 4 of desired thickness is formed on the coated core granules. The thickness of the shell 26 (FIG. 3) may be adjusted in view of the desired strength of the shell, i.e. it has to endure the stresses subjected thereto when both storing the fertilizer or soil conditioner in sacks or bags stacked one on top of another, and spreading the fertilizer or soil conditioner on the field, and/or in view of the ash (or other shell material) planned to be spread on the field. Another factor the thickness of the shell has an impact on is the time it takes for the fertilizer or soil conditioner granule to be dissolved by the humidity in the soil, i.e. the thicker is the shell the longer it takes for the granule to dissolve. The material S for the shell 26 is preferably ash, i.e. self-hardening ashes like hard coal ash or ash like, for instance, lime sludge ash collected from the reburning kiln, green liquor ash and ash from the bark boiler. In place of self-hardening ash, at least one of CaO, MgO, slag, alkali activated geopolymers, burned lime and calcium carbonate may be used, as they have a similar effect on both the fertilizer grenule, soil conditioner granule and the soil. Also, sugar slurry may be used either alone or in combination with one or more of the above listed and other applicable options to harden the surface layer, i.e. the shell, of the fertilizer or soil conditioner granule.

Applicable source of liquid L3 is water or, preferably, such circulation liquid from an appropriate process that does not contain any compound reactive, in such a manner that reduces the nutrient value of the shell material S or the nutrient/s in the liquid L3, with the coating material C or with the alkaline shell material S. For instance, industrial waste waters, like filtrates of mechanical wood processing, pulp and paper mill or sugar slurries of sugar industry, etc., containing nutrients may be used in the granulation process for forming the shell on the core granule. As further examples of such liquids that may be used as liquid L3 filtrates recovered from the digestate of anaerobic digestion, from the mash from various alcohol production processes or from the bio slurry (as examples of the vast number of options listed under bio-based matter in “Definitions”) may be mentioned. In other words, the third liquid L3 may contain nutrients in liquid form, but not nitrogen in a form sensitive to the pH of the alkaline layer. The nutrients and, optionally, soil conditioner/s and/or carbon, preferably bio carbon, may also be added in dry or liquid form either independently to the granulator or mixed with the liquid by means of a heavy duty mixer. The only prerequisite for the nutrient/s and/or soil conditioner/s and/or carbon, preferably bio carbon, to be added is that they need to withstand the moistening of the granular fertilizer or soil conditioner. Preferably, the fertilizer or soil conditioner granule is produced such that the dry matter content between the core/the first layer and the shell/the third layer is evenly shared i.e. 50%/50%. However, the share of the shell may be adjusted within a wide range depending on the desired speed of solubility, i.e. the longer the nitrogen is desired to remain within the fertilizer or soil conditioner granule the higher is the share of the shell, and vice versa. Also, the more alkaline the shell is the quicker is its solubility to the acidic soil, whereby, to resist quick solubility, the shell has to be made thicker.

Thereafter, the fertilizer or soil conditioner granules are, optionally, taken to the screen 38, where oversized, and possibly also undersized, granules are separated as reject R from the fertilizer or soil conditioner granules taken out as a fertilizer or soil conditioner F. The granular fertilizer or soil conditioner F is taken to be sacked or bagged, to be otherwise stored or to be sold directly. The rejected granules R may be either recycled, after having been ground to applicable coarseness back to the fertilizer or soil conditioner production or packed to be sold, for instance, for manual spreading or as a growing medium.

An option in the production of the granular fertilizer or soil conditioner is to perform the coating of the core granule and the formation of the shell in the same granulator. In other words, if, again, they are table, disc or drum granulators, the granulators 34 and 36 may be replaced with a single table, disc or drum granulator, which means that at a certain point of time, i.e. when a coating of the core granule has reached its desired thickness, the feed of coating material to the granulator is stopped, and the feed of ash or, in general, of the shell material is initiated. The coextruder discussed in more detail above is another option where both the core granule and the coating thereof are performed in the same apparatus.

It has to be understood, at this stage, that the present invention is not limited to the above discussed first or the second preferred embodiments or to their variations, but includes a number of other preferred embodiments and variations of the present invention. Firstly, it should be noticed that already when discussing the first preferred embodiment, it was taught, referring to FIG. 2 that the core granule 12 is in broader terms a first layer and the coating 14 is an inert barrier layer. However, there may be one or more further layer/s between the first layer 12 and the inert barrier layer 14. The only prerequisite for the material/s positioned in such layer/s is that the material/s should be inert in such a sense that it/they neither reacts/react nor has/have any negative influence on the nutrient and soil conditioner compounds in the core granule 12, nor such optionally provided in the inert barrier layer 14. In a similar manner, the second layer 14 may be provided, thereon, with at least one further layer without departing from the spirit of the present invention. Such a layer/s may be, in spite of the layer 26 discussed in FIG. 3, of any such material/s that does/do not react or has/have any negative influence on the nutrient and soil conditioner compounds optionally provided in the inert barrier layer 14.

As to the granular fertilizer or soil conditioner 20 of FIG. 3 having an alkaline third layer 26, it should be understood that it may be provided with one or more further layers between the core granule 22 and the barrier layer 24 and/or between the barrier layer 24 and the third layer 26, or one or more layers outside the third layer 26. Such layers may be used for, and provided with matter capable of, adjusting the solubility, the elasticity, the hardness and/or the dusting tendency of the fertilizer or soil conditioner granule. The only prerequisite for the material/s positioned in such layer/s is that the material/s should be inert in such a sense that it/they neither reacts/react nor has/have any negative influence on the nutrient and/or soil conditioner compounds in the neighboring layer/s, and that the neighboring layer/s does/do not have negative effects on the nutrient and/or soil conditioner compounds possibly provided in the further layer/s.

Thus, an optional granular fertilizer or soil conditioner having five layers may be formed, referring to the layers discussed in FIG. 3, of a core granule 22 of bio-based matrix, a layer rich in nitrogen or other nutrients, a barrier layer 24, a layer containing a soil conditioner, and an alkaline ash layer 26 rich in quickly dissolvable nitrogen (like CN, MAP or CAN).

The granular fertilizer or soil conditioner may also have an inert barrier layer outside the alkaline third layer 26 such that the barrier layer may be provided, in addition to the inert coating material, with such nutrient/s and/or soil conditioner/s and/or carbon, preferably bio carbon, that are desired to dissolve in the soil before the nutrient/s and/or soil conditioner/s and/or carbon, preferably bio carbon, provided in the inner layer/s of the granule. Naturally the nutrient/s and/or soil conditioner/s used in the fourth or inert layer are such that are insensitive to pH of the third layer 26.

Further, there may be another alkaline layer on top of the above mentioned inert barrier layer. The alkaline layer may be formed of one or more of the optional material/s discussed in connection with the inner alkaline layer, i.e. the shell 26 of FIG. 3. The outermost alkaline layer, especially when it is of ash, dissolves slowly in the acidic soil, whereby it may be arranged to carry such nutrient/s and/or soil conditioner/s and/or carbon, preferably bio carbon, that are needed by the plants soon after the spreading of the fertilizer. Naturally, again the nutrient and the fertilizer have to be insensitive to alkaline pH. In other words, phosphorus and potassium are directly applicable, but the nitrogen compounds that may be used are at least CN (calcium nitrate), CAN (calcium ammonium nitrate) and/or MAP (magnesium ammonium phosphate).

In other words, the additional layers may be provided for adjusting the overall solubility of the granular fertilizer or soil conditioner or for arranging the layers to define the order in which the different nutrients in different layers dissolve in the soil or for arranging the layers in the order they withstand the alkaline ash layer. In other words, it could be the layer containing CN, CAN or MAP that is located immediately below the ash layer, as it endures high pH. Or they may be arranged in the ash layer itself, if they should dissolve soon after the spreading of the fertilizer of soil conditioner. Such layers may also be used for, and provided with matter capable of, adjusting the elasticity, the hardness and/or the dusting tendency of the fertilizer or soil conditioner granule.

The granular fertilizer of the present invention may be used as a fertilizer in both growing of organic foodstuff, traditional foodstuff, agricultural foodstuff for livestock and forestry, whereby the requirements set for the fertilizer reduce, naturally, when coming from growing of foodstuff towards forestry. For instance, in Finland the allowed heavy metal content in fertilizers used in growing of organic food products is below 0,7 mg/kg bone dry (Cd) for the ash to be used as a part of the organic fertilizer, and below 1,5 mg/kg (Cd) for the ash to be used as a fertilizer in the production of fodder for livestock, or below 25 mg/kg (Cd) when used as a fertilizer in forestry. Also the type of nitrogen has an effect on the type of fertilizer, as in the organic fertilizers only such nitrogen may be used that has its origin in the recycled material. Another use for the granular fertilizer or soil conditioner of the present invention is an independent growing medium where various flowers or vegetables may be planted. And a further use of the soil conditioner of the present invention is to adjust the pH of the soil in addition to the fertilizing effect brought by the core granule with the nitrogen and macro and micro nutrients it contains.

As to the dimensioning of the fertilizer or soil conditioner granules, a starting point in their more or less industrial production is the requirement of modern spreading equipment, which are designed to work with the maximum diameter of 8 mm. Thus, the granules to be produced and aimed at machine type spreading need to be, today, of a size equal or less than 8 mm. However, in manual spreading or in the use as a growing medium the size of the granules does not play a role, whereby the production may be adjusted accordingly, i.e. either the end products of the entire production line need no screening (if all the production goes to manual spreading or for use as a growing medium) or the rejects of the screening at the end of the production may be packed for manual spreading or for use as a growing medium. The internal dimensions of the fertilizer or soil conditioner granule may vary a great deal, too. The core granule, i.e. the innermost layer of the granule may have a diameter as small as 1 mm, but it may also be up to 6-7 mm, if the maximum diameter of the granule is the 8 mm required by the spreading equipment. Naturally, if the maximum diameter of the granule has no actual limit, the core granule does not have such either. For a three-layer product shown in FIG. 3 the diameter of the core granule 22 may be 10-90% of the diameter of the end product, the alkaline third layer 26 may have a thickness of 90-10% of the of the diameter of the end product, and the inert barrier layer 24 may have a thickness of 1-95% of the of the diameter of the end product.

It is to be noted that above only a few most preferred embodiments of the present invention have been discussed. Thus, it is obvious that the invention is not restricted to the above described embodiments, but it may be applied in many different ways within the scope of the appended claims. The features of the present invention described in relation to a certain embodiment are within the basic concept of the invention, whereby they may be used in connection with another embodiment of the invention. Thereby also different features of the invention may be used in combination provided that such is desirable and the technical possibilities for that are available.

1. A two-layer granular fertilizer or soil conditioner including:
core granule comprising a bio-based matrix including bio-based matter containing nitrogen in a form of ammonium sensitive to pH, and
an inert barrier layer or coating provided outside the core granule and configured to maintain the pH of the core granule at a value of 8 or less to prevent conversion of ammonium to volatile ammonia.

2. The two-layer granular fertilizer or soil conditioner as recited in claim 1, wherein at least one nitrogen compound is in the bio-based matrix.

3. The two-layer granular fertilizer or soil conditioner as recited in claim 1, wherein the bio-based matter is recovered directly or indirectly from at least one of domestic waste, agricultural waste, municipal waste, and industrial waste and side flows.

4. The two-layer granular fertilizer or soil conditioner as recited in claim 1, wherein the bio-based matter is recovered from at least one of animal matter, human matter and vegetable matter.

5. The two-layer granular fertilizer or soil conditioner as recited in claim 1, wherein the bio-based matter is recovered from at least one of restaurant waste, bakery waste, slaughterhouse waste, fishery waste, dairy waste, sludges from waste water treatment plants and composted organic waste material.

6. The two-layer granular fertilizer or soil conditioner as recited in claim 1, wherein the bio-based matter is recovered from at least one of digestate from a biogas process, mash from an alcohol production process, and bio slurry of at least one of a mechanical wood processing, pulp, paper or sugar production plant

7. The two-layer granular fertilizer or soil conditioner as recited in claim 1, wherein the bio-based matrix further comprises at least one of kaolin, talcum, bentonite, silica, silicate, sugar slurry, polylactic acid (PLA) bio plastics, and inorganic compounds.

8. The two-layer granular fertilizer or soil conditioner as recited in claim 1, wherein the nitrogen compound originates from at least one of a bio-based matter and commercial nitrogen source.

9. The two-layer granular fertilizer or soil conditioner as recited in claim 1, wherein the nitrogen compound is at least one of: ammonium sulfate, ammonium nitrate, ammonium lactate, magnesium ammonium phosphate, calcium nitrate, calcium ammonium nitrate and urea.

10. The two-layer granular fertilizer or soil conditioner as recited in claim 1, wherein the nitrogen compound is recovered from a gaseous product, or from nitrogen-containing filtrates by stripping.

11. The two-layer granular fertilizer or soil conditioner as recited in claim 1, wherein the nitrogen compound originates from at least one of digestate from a biogas process, mash from various alcohol production processes and a filtrate recovered while thickening bio slurries at least one of domestic, agricultural, municipal and industrial waste and side flows.

12. The two-layer granular fertilizer or soil conditioner as recited in claim 1, wherein the nitrogen compound and the bio-based matter are recovered from a same process.

13. The two-layer granular fertilizer or soil conditioner as recited in claim 1, wherein the inert barrier layer includes at least one of kaolin, talcum, bentonite, silica, silicate, sugar slurry, polylactic acid (PLA), bio plastics, neutral or acidic geo polymers and bio-based matter.

14. The two-layer granular fertilizer or soil conditioner as recited in claim 1, wherein the core granule and/or the barrier layer comprises at least one of a macro nutrient, a micro nutrient, carbon and a soil conditioner.

15. A multi-layer granular fertilizer or soil conditioner comprising a core granule, an inert barrier layer and an alkaline third layer outside the inert barrier layer, wherein the core granule comprises a bio-based matrix of at least such bio-based matter that contains nitrogen in the form of ammonium sensitive to pH, and a pH of the core granule is at a value of 8 or less.

16. The multi-layer granular fertilizer or soil conditioner as recited in claim 15, wherein the bio-based matrix includes at least one nitrogen compound.

17. The multi-layer granular fertilizer or soil conditioner as recited in claim 15, wherein at least one further layer between the core granule and the inert barrier layer and/or between the inert barrier layer and the alkaline layer.

18. The multi-layer granular fertilizer or soil conditioner as recited in claim 15, wherein another barrier layer is positioned on the alkaline layer.

19. The multi-layer granular fertilizer or soil conditioner as recited in claim 18, wherein another alkaline layer is on the another barrier layer.

20. The multi-layer granular fertilizer or soil conditioner as recited in claim 15, wherien the bio-based matter is recovered directly or indirectly from at least one of a domestic, an agricultural, a municipal and/or an industrial waste.

21. The multi-layer granular fertilizer or soil conditioner as recited in claim 15, wherein the bio-based matter is recovered from at least one of animal matter, human matter and vegetable matter.

22. The multi-layer granular fertilizer or soil conditioner as recited in claim 15, wherien the bio-based matter is recovered from at least one of restaurant waste, bakery waste, slaughterhouse waste, fishery waste, dairy waste, sludges from waste water treatment plants and composted organic waste material.

23. The multi-layer granular fertilizer or soil conditioner as recited in claim 15, wherein the bio-based matter is recovered from at least one of digestate from a biogas process, mash from alcohol production processes and bio slurry of at least one of mechanical wood processing, pulp, paper and sugar production plant

24. The multi-layer granular fertilizer or soil conditioner as recited in claim 15, wherein the bio-based matrix comprises at least one of kaolin, talcum, bentonite, silica, silicate, sugar slurry, polylactic acid (PLA) or bio plastics, and inorganic compounds.

25. The multi-layer granular fertilizer or soil conditioner as recited in claim 15, wherein the nitrogen compound originated from one of a bio-based matter and a commercial nitrogen source.

26. The multi-layer granular fertilizer or soil conditioner as recited in claim 17, wherein the nitrogen compound includes at least one of: ammonium sulfate, ammonium nitrate, ammonium lactate, magnesium ammonium phosphate, calcium nitrate, calcium ammonium nitrate and urea.

27. The multi-layer granular fertilizer or soil conditioner as recited in claim 17, wherein the nitrogen compound is recovered from a gaseous product, or from nitrogen-containing filtrates.

28. The multi-layer granular fertilizer or soil conditioner as recited in claim 17, wherein the nitrogen compound originates from at least one of digestate from a biogas process, mash from alcohol production processes and a filtrate recovered while thickening bio slurries in at least one of domestic, agricultural, municipal and industrial waste and side flows.

29. The multi-layer granular fertilizer or soil conditioner as recited in claim 17, wherein the nitrogen compound and the bio-based matter are recovered from a same process.

30. The multi-layer granular fertilizer or soil conditioner as recited in claim 15, wherein the inert barrier layer comprises at least one of kaolin, talcum, bentonite, silica, silicate, sugar slurry, polylactic acid (PLA), bio plastics, neutral or acidic geo polymers and a bio-based matter.

31. The multi-layer granular fertilizer or soil conditioner as recited in claim 15, wherein the alkaline third layer is made of at least one of self-hardening ash, calcium carbonate, magnesium oxide, burned lime, calcium oxide, slag and alkali activated geo polymers.

32. The multi-layer granular fertilizer or soil conditioner as recited in claim 15, wherein the core granule and/or the barrier layer and/or the alkaline layer comprises at least one of a macro nutrient, a micro nutrient, carbon and a soil conditioner.

33. The multi-layer granular fertilizer or soil conditioner as recited in claim 15, wherein the barrier layer and/or the alkaline layer comprises nitrogen in the form of at least one of magnesium ammonium phosphate or calcium ammonium nitrate or calcium nitrate.

34. The multi-layer granular fertilizer or soil conditioner as recited in claim 31, wherein the self-hardening ash is at least one of coal ash, hard coal ash, lime sludge ash, green liquor and bark boiler ash.

35. The two-layer granular fertilizer or soil conditioner as in claim 1 configured as a fertilizer for production of organic foodstuff.

36. The two-layer granular fertilizer or soil conditioner in claim 1 configured as a fertilizer for production of foodstuff.

37. The two-layer granular fertilizer or soil conditioner configured as a fertilizer for production of agricultural foodstuff for livestock.

38. The two-layer granular fertilizer or soil conditioner in claim 1 configured as a fertilizer in forestry.

39. The two-layer granular fertilizer or soil conditioner in claim 1 configured as a growing medium.
